(19) United States
(12) Patent Application Publication
(10) Pub. No.: US 2016/0256715 A1
(43) Pub. Date: Sep. 8, 2016

(54) Air-Filtering Device

(71) Applicants: Chao-Chih Chao, Changhua City (TW); Chin-Hsin Lin, Huatan Township (TW); Kuo-Fang Wang, Changhua City (TW)

(72) Inventors: Chao-Chih Chao, Changhua City (TW); Chin-Hsin Lin, Huatan Township (TW); Kuo-Fang Wang, Changhua City (TW)

(21) Appl. No.: 14/878,032

(22) Filed: Oct. 8, 2015

(30) Foreign Application Priority Data
Mar. 4, 2015 (TW) 104203188

(51) Int. Cl. A62B 23/06; A62B 9/06

(52) U.S. Cl. CPC A62B 23/06; A62B 9/06

(57) ABSTRACT

An air-filtering device has an outer plug, an inner plug, a nose clip, and a filter. The outer plug has a contacting portion and flip lid pivotally connected to the contacting portion. The contacting portion has a first receiving space. The flip lid has a second receiving space. The inner plug is mounted in the outer plug and has a third receiving space communicating with the first receiving space and the second receiving space. The nose clip is connected to the flip lid to connect the outer plug securely with the nose clip. The filter is mounted in the third receiving space of the inner plug.

### BACKGROUND OF THE INVENTION

1. Field of the Invention

The present invention relates to an air-filtering device, and more particularly to an air-filtering device that can be mounted in a human nostril conveniently and easily to provide an air-filtering function to the human.

2. Description of Related Art

With the development of technology, various inventions bring convenience to life. However, people need to bear impact of technology for the environment when enjoying the convenience of life by the science and technology at the same time. Among them, air pollution is one of the worse examples. Under bad air quality, a common method is to wear a conventional mask outdoors. When wearing the conventional masks for covering nose and mouse together, the user normally feel uncomfortable with bad filtering quality.

In order to solve the above-mentioned shortcomings of the conventional masks, a conventional invisible mask has been developed that can be directly mounted into the nasal vestibule/nostril of human to solve the above-mentioned shortcomings of the conventional masks.

However, the conventional invisible masks still have many problems causing the inconvenience of use, such as gas flow is not enough that leading problem of short of breath.

In addition, the conventional invisible mask is manufactured as a single piece. Any part of the conventional mask is broken, the conventional invisible mask cannot replace part but needs to be discarded whole set

To overcome the shortcomings, the present invention provides an air-filtering device to mitigate or obviate the aforementioned problems.

### SUMMARY OF THE INVENTION

The main objective of the present invention is to provide an air-filtering device that can be mounted in human nostrils conveniently and easily to provide an air-filtering function to users.

The air-filtering device has an outer plug, an inner plug, a nose clip, and a filter. The outer plug has a contacting portion and flip lid pivotally connected to the contacting portion. The contacting portion has a first receiving space. The flip lid has a second receiving space. The inner plug is mounted in the outer plug and has a third receiving space communicating with the first receiving space and the second receiving space. The nose clip is connected to the flip lid to connect the outer plug securely with the nose clip. The filter is mounted in the third receiving space of the inner plug. The present invention has the following advantages: different materials can be used to provide a composite performance in manufacture, the components of the air-filtering device can be separated and replaced individually, the flux of breathing can be increased by a venting structure of the inner plug and different agents can be filled in the inner plug.

Other objectives, advantages and novel features of the invention will become more apparent from the following detailed description when taken in conjunction with the accompanying drawings.

### BRIEF DESCRIPTION OF THE DRAWINGS

FIG. 1 is an operational side view of a first embodiment of an air-filtering device in accordance with the present invention;

FIG. 2 are exploded perspective views of the air-filtering device in FIG. 1 and a second embodiment of an air-filtering device in accordance with the present invention;

FIG. 3 is a front perspective view of the air-filtering device in FIG. 1;

FIG. 4 is a rear perspective view of the air-filtering device in FIG. 1;

FIG. 5 is an enlarged perspective view of an outer plug of the air-filtering device in FIG. 4;

FIG. 6 is an enlarged perspective view of a first embodiment of an inner plug of the air-filtering device in FIG. 4;

FIG. 7 is an enlarged perspective view of a second embodiment of an inner plug of the air-filtering device in FIG. 4;

FIG. 8 is an enlarged perspective view of a nose clip of the air-filtering device in FIG. 3;

FIG. 9 is a cross sectional top view of the air-filtering device in FIG. 3; and

FIG. 10 is a cross sectional top view of the air-filtering device with two embodiments of filter in accordance with the present invention.

### DETAILED DESCRIPTION OF THE PREFERRED EMBODIMENT

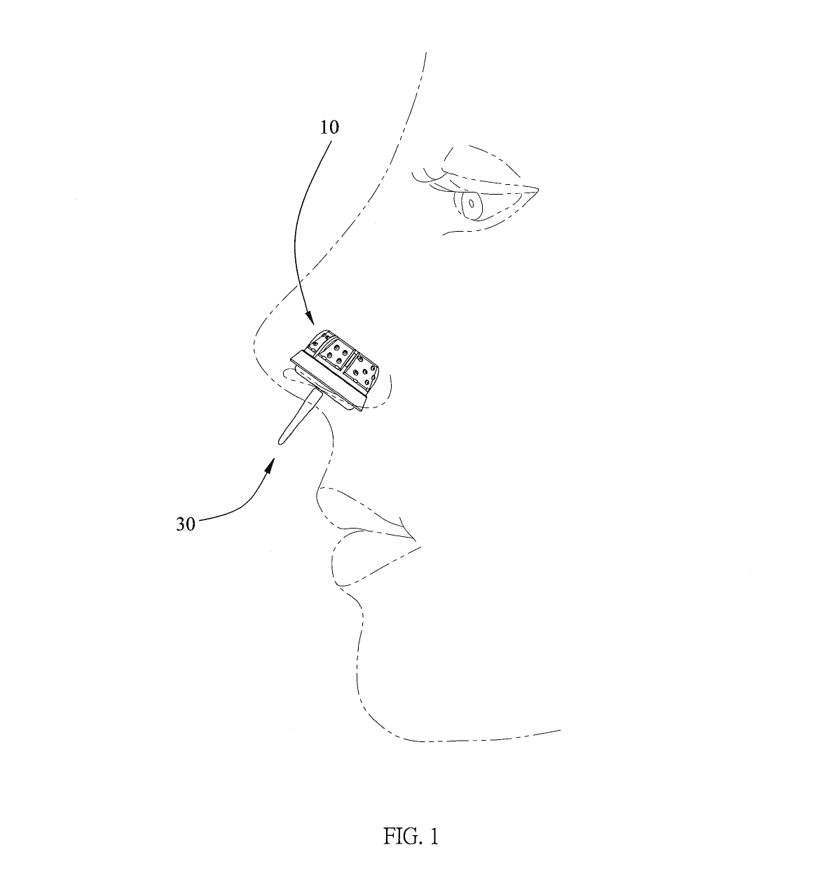

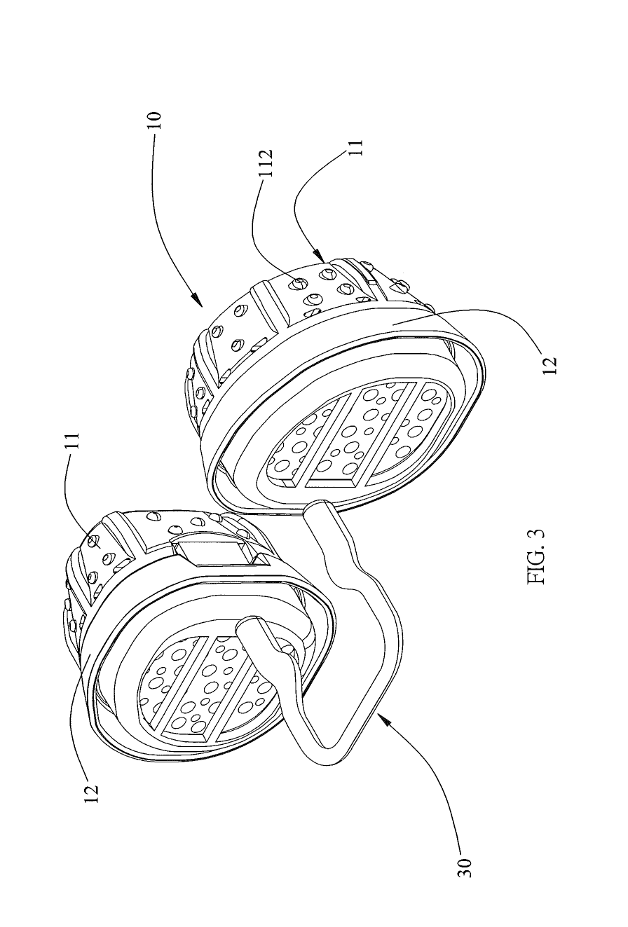

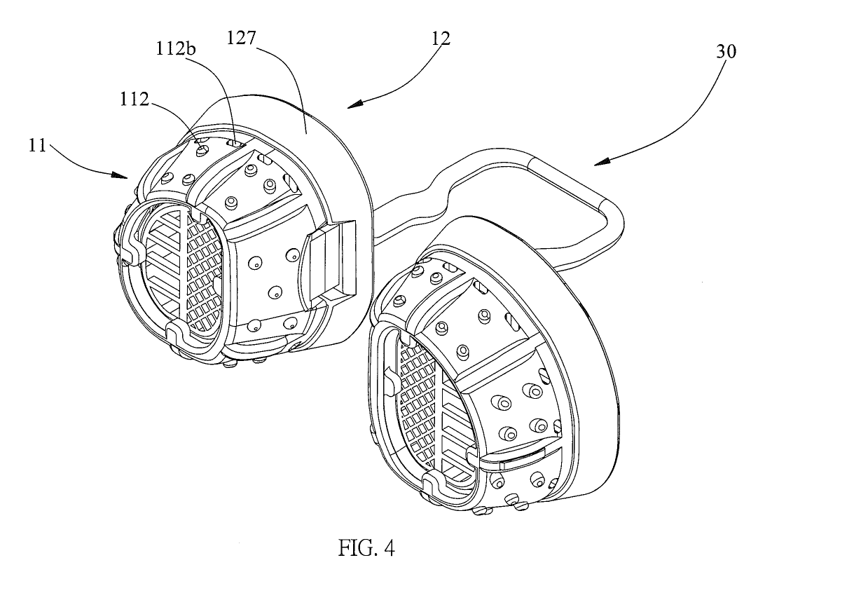

With reference to FIGS. 1 to 4, a first embodiment of an air-filtering device in accordance with the present invention comprises an outer plug 10, an inner plug 20, a nose clip 30, and a filter 40. The outer plug 10 has an outer contour corresponding to a shape of a nasal vestibule/nostril of human. The inner plug 20 and the filter 40 are mounted in outer plug 10. The nose clip 30 is connected to the outer plug 10, the outer plug 10 is mounted in the nasal vestibule of human and the nose clip 30 is clamped between two nostrils of the nose to hold the air-filtering device securely on nose.

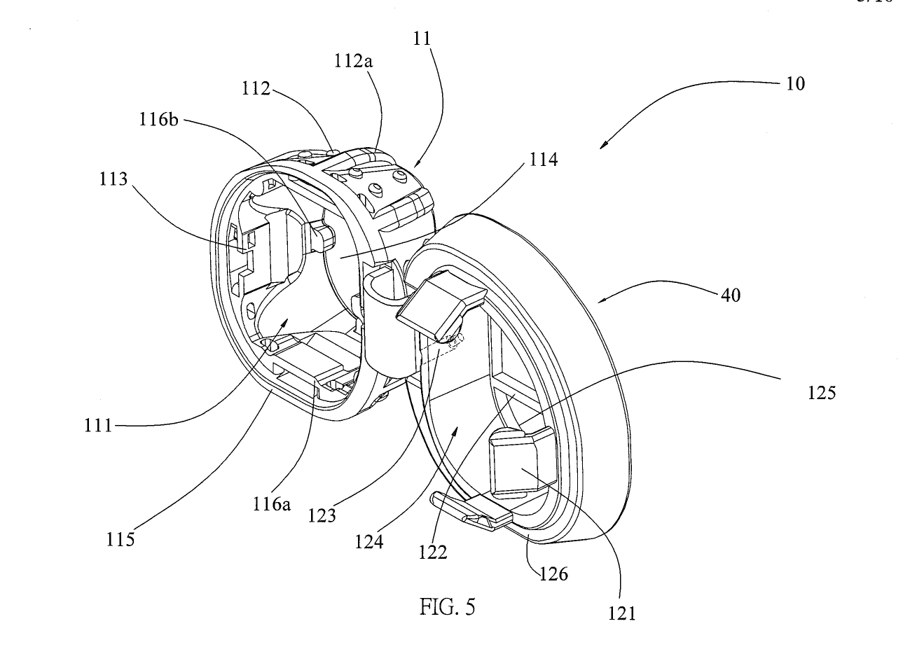

With reference to FIG. 5, the outer plug 10 has a contacting portion 11 and a flip lid 12. The flip lid 12 is pivotally connected to the contacting portion 11 by a pivot rod to rotate relative to the contacting portion 11 to close or open the contacting portion 11.

The contacting portion 11 has a first receiving space 111, a contacting structure 112, and a first connect structure 113. Furthermore, the contacting portion 11 is a groove structure with a through hole to form the first receiving space 111. The contacting portion 11 has two free ends, a first nose opening 114, and a first connect opening 115. The first nose opening 114 and the first connect opening 115 are respectively formed on the two free ends of the contacting portion 11.

The first receiving space 111 communicates with a human's nasal vestibule via the first nose opening 114 and the first connect opening 115, air may flow between the first receiving space 111 and the nasal vestibule of human. During use, the first nose opening 114 faces toward the human's nasal vestibule to mount the outer plug 10 into the human's nasal vestibule.

The contacting structure 112 is formed on an external surface of the contacting portion 11 to form a gap between an external surface of the outer plug 10 and an inner skin of the nasal vestibule, and this can prevent the smooth external surface of the outer plug 10 from excessive fitting with the inner skin of the nasal vestibule thus increasing the difficulty to remove the outer plug 10 from the human's nasal vestibule. In addition, the contacting structure 112 may be but not limited to recesses formed in or protrusions formed on the external surface of the outer plug 10.

Additionally, the contacting portion 11 has multiple ventilating ribs 112a. The ventilating ribs 112a are formed around the external surface of the contacting portion 11 at intervals to form a rib structure outward the external surface of the contacting portion 11. The ventilating ribs 112a that protrude outwardly from the external surface of the contacting portion 11 can form multiple passages between the human's nasal vestibule and the external surface of the contacting portion 11 when the outer plug 10 is mounted into the human's nasal vestibule. The passages are conductive to the circulation of air and liquid in the human's nasal vestibule when breathing.

Furthermore, the contacting portion 11 has multiple ventilating holes 112b. The ventilating holes 112b are formed through the external surface of the contacting portion 11 at intervals to enable the first receiving space 111 to communicate with the human's nasal vestibule. Then, the ventilating holes 112b are conductive to the circulation of air and can prevent the nasal fluid from accumulating between the outer plug 10 and the nasal vestibule.

The flip lid 12 is pivotally connected to the contacting portion 11 and has a second connect structure 121, an external vent structure 122, a second receiving space 124, and a clip recess 123. The flip lid 12 is a groove structure with a through hole to form the second receiving space 124. The flip lid 12 has two free ends, a first outer opening 125, and a second connect opening 126. The first outer opening 125 and the second connect opening 126 are respectively formed on the two free ends of the flip lid 12 and communicate with the second receiving space 124. When the flip lid 12 is rotated to mount on the contacting portion 11, the first receiving space 111 and the second receiving space 124 communicate with the nasal vestibule of human via the first nose opening 114, the first connect opening 115, the second connect opening 126, and the first outer opening 125. In use, the first outer opening 125 faces against the human's nose to mount the outer plug 10 into the nasal vestibule of human. The external vent structure 122 is formed on the flip lid 12 at the first outer opening 125, and may be a fence or mesh structure. The external vent structure 122 can prevent an object that is mounted between the receiving spaces 111, 124 from falling out of the outer plug 10 via the first outer opening 125 after the flip lid 12 is rotated to mount on the contacting portion 11. The contacting portion 11 is securely connected to the flip lid 12 by the first connect structure 113 and the second connect structure 121. The first connect structure 113 is formed in the contacting portion 11 at the first connect opening 115, and the second connect structure 121 is formed on the flip lid 12 at the second connect opening 126. The first connect opening 115 has an outer contour corresponding to an outer contour of the second connect opening 126, and this can enable first connect opening 115 corresponding to the second connect opening 126 when the contacting portion 11 is connected to the flip lid 12. In addition, the first connect structure 113 may be a connecting recess, and the second connect structure 121 may be a connecting tab. The connecting tab is inserted into engages in the connecting recess to hold the flip lid 12 securely with the contacting portion 11. Furthermore, the outer plug 10 has multiple sets of first connect structure 113 and second connect structure 121, and this can enable the flip lid 12 to securely connect with the contacting portion 11.

Additionally, the flip lid 12 has a retaining ring 127 mounted on an external surface of the flip lid 12. The retaining ring 127 is annular and has a gap relative to the external surface of the flip lid 12, and the outer plug 10 can abut the inner skin of the human's nasal vestibule by the retaining ring 127. In addition, the gap between the retaining ring 127 and the flip lid 12 can enable the retaining ring being deformable relative to the flip lid 12 and to fit with an inner contour of the human's nasal vestibule.

The outer plug 10 can be made by a special treatment or adding functional material in the manufacture process to have additional functions. For example, the outer plug 10 is made of materials that can emit infrared light or negative ions, is made of materials that have antibacterial functions such as nano silver an or is made of materials that have special aromas such as fruity, floral or mint, etc., so that the outer plug 10 has a special aroma. Alternatively, the outer plug 10 may be made of flexible materials to enable the outer plug 10 to deform to fit the different contours of the human's nasal vestibule, and this can reduce the discomfort to the user.

Additionally, the outer plug 10 has an antiskid structure formed on the external surface of the outer plug 10 to increase the friction when a user picks up the outer plug 10, and the antiskid structure may be multiple protrusions, multiple indentations or multiple nicks.

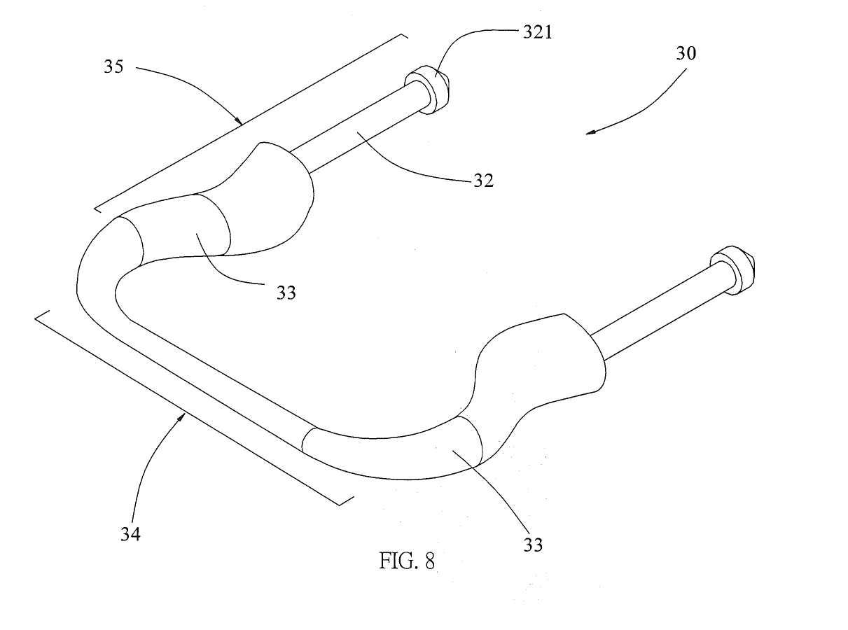

With reference to FIGS. 5 and 8, the clip recess 123 is formed in the external surface of the flip lid 12 and is connected to the nose clip 30. The nose clip 30 has a connecting segment 32 and an adjusting segment 33. Preferably, the nose clip 30 is connected to two outer plugs 10. The connecting segment 32 is formed on two free ends of the nose clip 30 and is connected to the clip recesses 123 of the two outer plugs 10 to hold the two outer plugs 10 securely with the nose clip 30. In addition, the connecting segment 32 has two engaging protrusions 321 respectively formed on the free ends of the nose clip 30 and respectively mounted in and engaging the clip recesses 123 of the two outer plugs 10. The nose clip may be a U-shaped rod and is corresponding to a nose width of human. In addition, the adjusting segment 33 is mounted on a part of the nose clip 30 and has a structure with a retractable function. For example, the nose clip 30 has a longitudinal part 34 and a transversal part 35, and the free ends of the nose clip 30 along the transversal part 35 can be extended or a length of the longitudinal part 34 can be adjusted by rotating the free ends of the nose clip 30 through an internal threaded structure. Furthermore, a length of the nose clip 30 can be adjusted by forming engaging grooves of different depths in the nose clip 30 to co-operate with users' noses of different heights or widths.

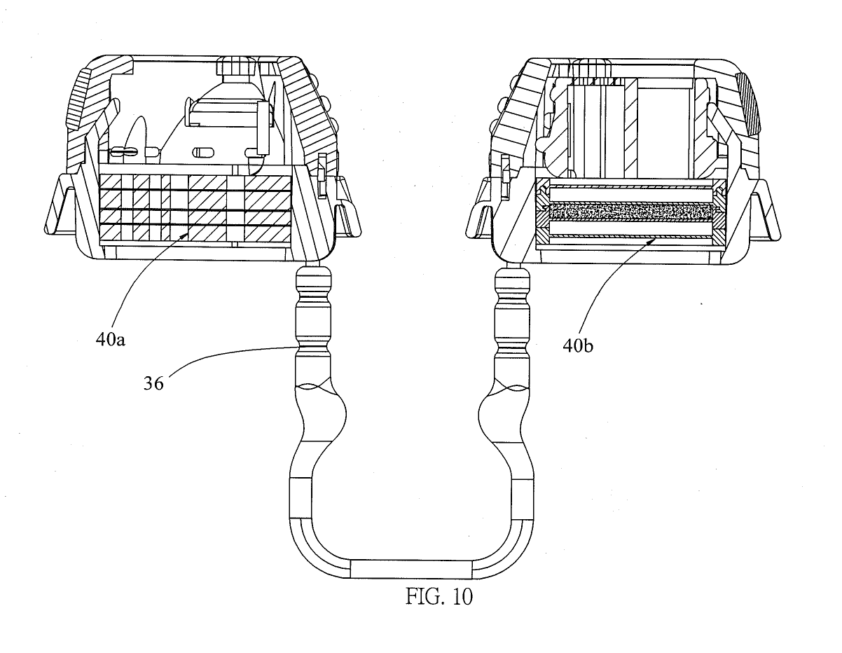

Additionally, with reference to FIG. 10, the nose clip 30 further has a bending segment 36 formed on the longitudinal part 34 of the noise clip 30, and the bending segment 36 is recessed to enable the nose clip 30 to bend. In use, the positions of the two outer plugs 10 that mounted in the nasal vestibule of human may be different, and this may make the transversal part 35 of the nose clip 30 slanting relative to the nose of human to affect the appearance. The oblique transversal part 35 of the nose clip 30 can be adjusted horizontally by bending the bending segment 36 of the nose clip 30 to maintain the appearance.

In the actual use, each outer plug 10 is mounted in each nostril of human, and each outer plug 10 has a clip recess 123, and the two free ends of the nose clip 30 are respectively and securely mounted in the clip recesses 123 of the two outer plugs 10 to hold the two outer plugs 10 securely with the nose clip 30 to provide a air-filtering effect to human.

In addition, with reference to FIG. 5, the outer plug 10 further has at least one first fixing structure 116 formed in the outer plug 10, and the at least one first fixing structure 116 has two embodiments, the first embodiment of the at least one fixing structure 116 is defined as 1116a and is formed in the outer plug 10 adjacent to the first connect opening 115, and the second embodiment of the at least one fixing structure 116 is defined as 116b and is formed in the outer plug 10 adjacent to the first nose opening 114.

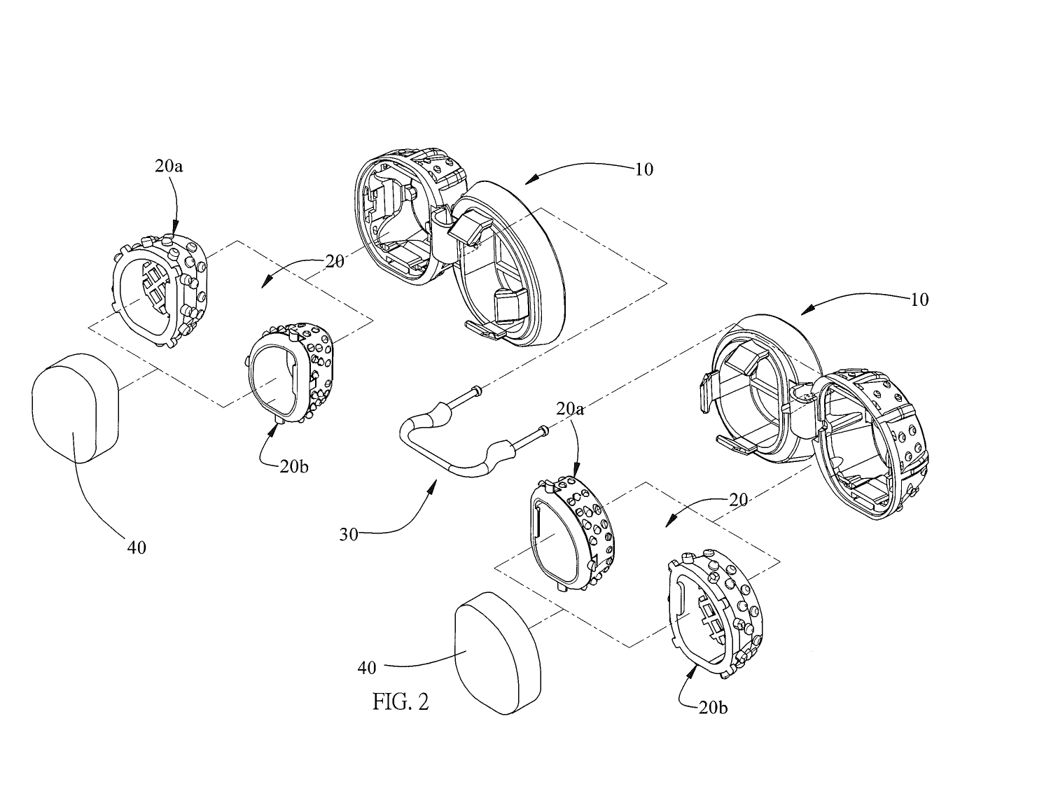

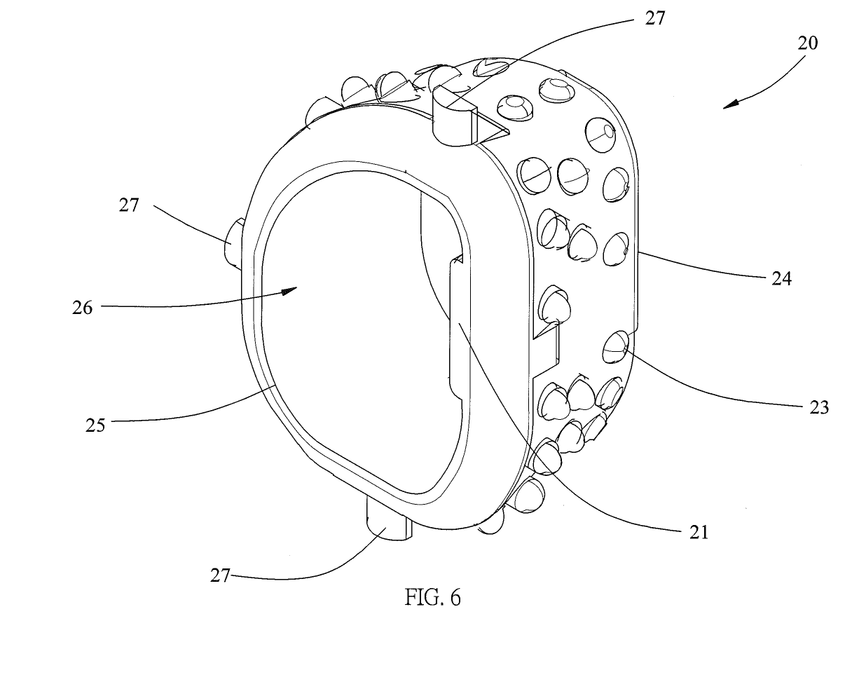

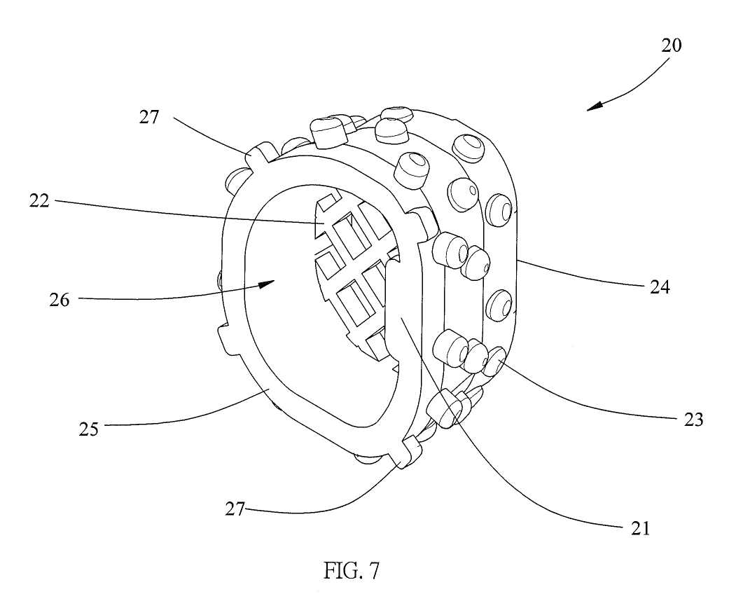

With reference to FIGS. 6 and 7, the inner plug 20 and the filter 40 are mounted in the outer plug 10 between the first receiving space 111 of the contacting portion 11 and the second receiving space 124 of the flip lid 12. In addition, the inner plug 20 may have two embodiments, a first embodiment of the inner plug 20 is shown as 20a in FIGS. 2 and 7, and a second embodiment of the inner plug 20 is shown as 20b in FIGS. 2 and 6.

In the first embodiment of the inner plug 20a, the inner plug 20a has a finger grip 21, a venting structure 23, a second nose opening 24, a second outer opening 25, a third receiving space 26, and at least one second fixing structure 27. The inner plug 20 is a groove structure with a through hole. The second nose opening 24 and the second outer opening 25 respectively formed through two free ends of the inner plug 20. The third receiving space 26 is formed in the inner plug 20 and communicates with the second nose opening 24 and the second outer opening 25. In addition, the third receiving space 26 communicates with the first receiving space 111, the second receiving space 26, and the nasal vestibule of human via the second nose opening 24 and the second outer opening 25. In use, the second nose opening 24 faces toward the first nose opening 114 to mount the inner plug 20 into the outer plug 10. In the second embodiment of the inner plug 20, the inner plug 20b is substantially the same as the first embodiment except for the following features. The inner plug 20b further has a holding structure 22 mounted in the inner plug 20b adjacent to the second nose opening 24.

The at least one second fixing structure 27 is formed on and protrudes from an external surface of the inner plug 20 adjacent to the second outer opening 25, and selectively engages the first fixing structure 116 of the outer plug 10 to hold the inner plug 20 securely in the outer plug 10 without sliding. In addition, the at least one second fixing structure 27 engages the first fixing structure 116a that formed in the outer plug 10 adjacent to the first connect opening 115, and the external surface of the inner plug 20 adjacent to the second nose opening 124 engages the first fixing structure 116b that formed in the outer plug 10 adjacent to the first nose opening 114. Furthermore, the first connect structure 113 and the second connect structure 121 may be a mutual engagement or connection structure.

The venting structure 23 is formed on the external surface of the inner plug 20 to prevent the inner plug 20 from excessive fitting with the outer plug 10 to reduce the flow flux of air flowing through the inner plug 20 and the outer plug 10, and the user may breathe unsmooth. In addition, the venting structure 23 can increase an area of the external surface of the outer plug 10 contacting air. Furthermore, the venting structure 23 may be curved or multiple protrusions formed on the external surface of the inner plug 20, and the multiple protrusions can form multiple contacting points on an inner surface of the outer plug 10, and this can increase the air flux and the contacting area of air.

The finger grip 21 is formed on the inner plug 20 at the second outer opening 25, is a protruding block and extends toward the third receiving space 26, and the inner plug 20 can be mounted in or removed from the outer plug 10 by a user contacting the finger grip 21. Furthermore, the holding structure 22 that is formed in the inner plug 20 adjacent to the second nose opening 24 may be a fence or mesh structure to prevent an object mounted in the inner plug 20 from falling out of the third receiving space 26.

The inner plug 20 can be made by a special treatment or adding functional material in the manufacture process to have additional functions. For example, the inner plug 20 is made of materials that can emit infrared light or negative ions, is made of materials that have antibacterial functions such as nano silver an or is made of materials that have special aromas such as fruity, floral or mint, etc., so that the inner plug 20 has a special aroma. In addition, the venting structure 23 can increase the contacting area of air and this can improve the contacting area between air and the functional materials of the inner plug 20.

When the inner plug 20 and the filter 40 are mounted in the outer plug 10 between the first receiving space 111 and the second receiving space 124, the filter 40 is mounted between the second outer opening 25 of the inner plug 20 and the first outer opening 125 of the flip lid 12. Outside air is sucked by a user and is flowed into the nasal vestibule of the user sequentially via the nostrils of user, the first outer opening 125, the filter 40, the second outer opening 25, the second receiving space 124, the second nose opening 24, and the first nose opening 114. The filter 40 may be a medical-grade foam or is made of pore material, activated carbon, nano silver, non-woven cloth, stainless steel mesh, etc. that can provide a filtering function.

With reference to FIG. 10, the filter 40 has two embodiments, a first embodiment of the filter 40 is defined as 40a, and a second embodiment of the filter 40 is defined as 40b. In the first embodiment of the filter 40, the filter 40a has multiple layers with perforations to form a multilayer structure, and the multilayer structure may be made of non-woven cloth or medical-grade foam. The layers of the multilayer structure are connected to each other by sticking, engaging or connecting the layers by a series member, and the thickness of the multilayer structure of the filter 40a can be adjusted according to the user's need. In addition, the perforations are formed through the layers and align with each other, and this can enable air to flow through the multilayer structure via the perforations to provide an air filtering effect and maintain the air flux.

With further reference to FIG. 10, in the second embodiment of the filter 40, the filter 40b has multiple layers to form a multilayer structure. The multilayer structure has a closed space and may be made of non-woven cloth or medical-grade foam. The layers of the multilayer structure are connected to each other by sticking or engaging. A filtering power can be wholly or partially filled in the filter 40b, and the sizes of the perforations of the layers are smaller than the size of the filtering power to prevent the filtering power from flowing out of the filter 40b when the air flows through the filter 40b. Since the filtering power is filled in the closed space of the multilayer structure, and the filter 40b has dual filtration efficiency by the multilayer structure and the filtering power. In addition, the filtering power may be activated carbon powder or other filtering effect of powder.

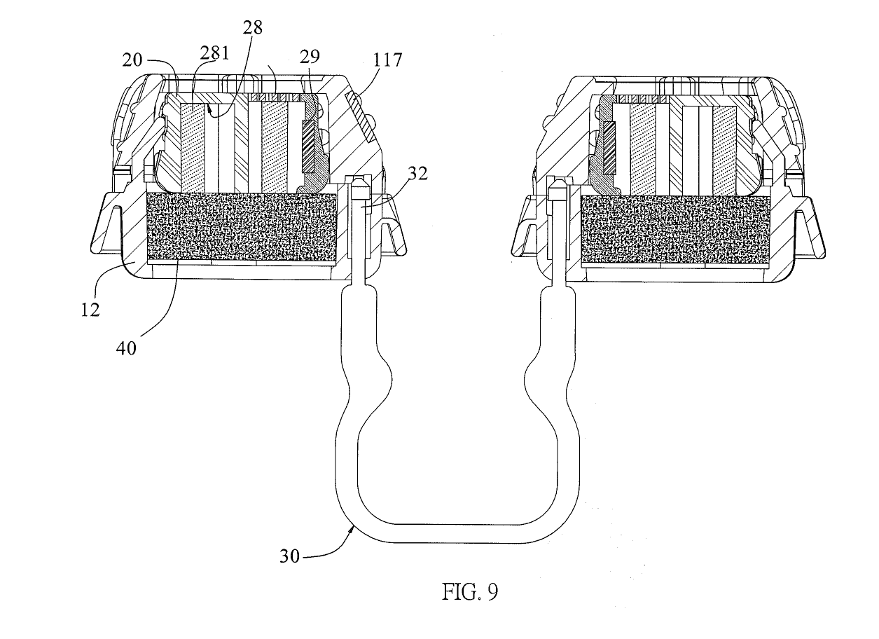

With reference to FIG. 9, the inner plug 20 further has a fourth receiving space 28 formed in the third receiving space 26, and the fourth receiving space 28 has a through hole communicating with the third receiving space 26. Then, an object such as inhalation agents or volatile agents 281 that mounted in the fourth receiving space 28 can flow with air into the nasal vestibule of human.

Furthermore, the contacting portion 11 has a physiological sensor device 117 mounted in or on the external surface of the contacting portion 11 to detect a physiological condition in the nasal vestibule by an induction end or a sensing surface. For example, the physiological condition may be the user's nose flow or the temperature in the nose. In addition, the sensing result of the physiological condition can be sent by a signal and can be received by an external device, for example, a radio signal is sent and is received by a mobile device, phone or computer.

Additionally, the inner plug 20 has an air quality sensing device 29 mounted in or on an inner surface of the inner plug 20 to detect a quality of air that flows in the nasal vestibule by an induction end or a sensing surface. The sensing result of the quality of air can be sent by a signal and can be received by an external device, for example, a radio signal is sent and is received by a mobile device, phone or computer.

According to the above-mentioned features and structural relationships, the air-filtering device in accordance with the present invention has the following advantages.

1. At the time of manufacturing the air-filtering device, different materials can be used to provide extra performance, such as infrared radiation, negative ions, antibacterial or flavor, etc.

2. The components of the air-filtering device can be separated, a broken component of the air-filtering device can be replaced individually to avoid waste.

3. The venting structure 23 being formed on the external surface of the inner plug 20, 20a, 20b can increase the flux of breathing air and can prevent breath unsmooth problem.

4. The internal structure of the inner plug 20, 20a, 20b can be filled with different agents in the inner plug 20, 20a, 20b according to the users' needs.

What is claimed is:

1. An air-filtering device having:
an outer plug having
a contacting portion being a groove structure with a through hole and having
two free ends;
a first nose opening formed on one of the two free ends of the contacting portion;
a first connect opening formed on the other free end of the contacting portion; and
a first receiving space formed in the contacting portion between the two free ends of the contacting portion and communicating with a nasal vestibule of human via the first nose opening and the first connect opening when the outer plug is mounted in a nose of human; and
a flip lid being a groove structure, pivotally connected to the contacting portion, and having
two free ends;
a first outer opening formed on one of the two free ends of the flip lid;
a second connect opening formed on the other free end of the flip lid;
a second receiving space formed in the flip lid between the two free ends of the flip lid and communicating with the first outer opening and the second connect opening; and
wherein the first receiving space and the second receiving space communicate with the nasal vestibule of human via the first nose opening, the first connect opening, the second connect opening, and the first outer opening; and
an inner plug mounted in the outer plug and having
two free ends;
a second nose opening formed on one of the two free ends of the inner plug;
a second outer opening formed on the other free end of the inner plug;
a third receiving space formed in the inner plug between the two free ends of the inner plug and communicating with the second nose opening and the second outer opening; and
wherein the third receiving space communicates with the first receiving space, the second receiving space, and the nasal vestibule of human via the second nose opening and the second outer opening.

2. The air-filtering device as claimed in claim 1, wherein
the flip lid has a clip recess formed in an external surface of the flip lid; and
the air-filtering device further has a nose clip connected to the outer plug, and the nose clip has
two free ends; and
a connecting segment formed on the two free ends of the nose clip and securely mounted in the clip recess of the flip lid to hold the outer plug with the nose clip.

3. The air-filtering device as claimed in claim 2, wherein
the inner plug is mounted in the outer plug between the first receiving space and the second receiving space; and
the air-filtering device further has a filter mounted in the inner plug between the second outer opening of the inner plug and the first outer opening of the flip lid.

4. The air-filtering device as claimed in claim 3, wherein the nose clip is U-shaped and has an adjusting segment partially mounted on the nose clip.

5. The air-filtering device as claimed in claim 4, wherein the inner plug further has a fourth receiving space formed in the third receiving space and having a through hole communicating with the third receiving space.

6. The air-filtering device as claimed in claim 5, wherein the inner plug has a venting structure formed on an external surface of the inner plug, being curved or having multiple protrusions to increase contacting area of air to the outer plug.

7. The air-filtering device as claimed in claim 6, wherein the contacting portion of the outer plug has a contacting structure formed on an external surface of the contacting portion to form a gap between the outer plug 10 and an inner skin of the nasal vestibule of human, and the contacting structure is curved or has recesses formed in the external surface of the contacting portion.

8. The air-filtering device as claimed in claim 7, wherein
the contacting portion of the outer plug further has a physiological sensor device mounted in or on the external surface of the contacting portion to detect a physiological condition in the nasal vestibule of human by an induction end or a sensing surface of the physiological sensor device; and
the inner plug has an air quality sensing device mounted in or on an inner surface of the inner plug to detect a quality of air that flows in the nasal vestibule of human by an induction end or a sensing surface of the air quality sensing device.

9. The air-filtering device as claimed in claim 8, wherein the outer plug and the inner plug are made of materials that have antibacterial function or special flavor.

10. The air-filtering device as claimed in claim 8, wherein
the filter has multiple layers to form a multilayer structure, and the multilayer structure has a closed space; and
the air-filtering device has a filtering power filled in the closed space of the multilayer structure.

11. The air-filtering device as claimed in claim 8, wherein the nose clip further has a bending segment formed on the noise clip, and the bending segment is recessed to enable the nose clip to bend.
